(19) United States
(12) Patent Application Publication
(10) Pub. No.: US 2019/0053264 A1
(43) Pub. Date: Feb. 14, 2019

(54) APPARATUSES AND METHODS FOR A USER EQUIPMENT (UE) TO HANDLE MULTIPLE SCHEDULING REQUEST (SR) PROCEDURES

(71) Applicant: MEDIATEK INC., Hsin-Chu (TW)

(72) Inventors: Guan-Yu LIN, Hsin-Chu (TW); Xiu-Sheng LI, Hsin-Chu (TW); Chia-Chun HSU, Hsin-Chu (TW)

(21) Appl. No.: 16/054,047

(22) Filed: Aug. 3, 2018

Related U.S. Application Data
(60) Provisional application No. 62/542,884, filed on Aug. 9, 2017.

(51) Int. Cl. H04W 72/12; H04W 48/02

(52) U.S. Cl. CPC H04W 72/1284; H04W 72/1215; H04W 72/1236; H04W 72/1242; H04W 48/02

(57) ABSTRACT

A User Equipment (UE) including a wireless transceiver and a controller is provided. The wireless transceiver performs wireless transmission and reception to and from a serving cell. The controller performs a first Scheduling Request (SR) procedure and a second SR procedure with the serving cell via the wireless transceiver, and maintains a first set of SR parameters for the first SR procedure and a second set of SR parameters for the second SR procedure, in response to performing the first SR procedure and the second SR procedure.

### CROSS REFERENCE TO RELATED APPLICATIONS

This Application claims priority of U.S. Provisional Application No. 62/542,884, filed on Aug. 9, 2017, the entirety of which is incorporated by reference herein.

### BACKGROUND OF THE APPLICATION

### Field of the Application

The application generally relates to Scheduling Request (SR) procedures and, more particularly, to apparatuses and methods for a UE to handle multiple SR procedures.

### Description of the Related Art

With the growing demand for ubiquitous computing and networking, various cellular technologies have been developed, including Global System for Mobile communications (GSM) technology, General Packet Radio Service (GPRS) technology, Enhanced Data rates for Global Evolution (EDGE) technology, Wideband Code Division Multiple Access (WCDMA) technology, Code Division Multiple Access 2000 (CDMA2000) technology, Time Division-Synchronous Code Division Multiple Access (TD-SCDMA) technology, Worldwide Interoperability for Microwave Access (WiMAX) technology, Long Term Evolution (LTE) technology, Time-Division LTE (TD-LTE) technology, and LTE-Advanced (LTE-A) technology, etc.

These cellular technologies have been adopted in various telecommunication standards to provide a common protocol that enables different wireless devices to communicate on a municipal, national, regional, and even global level. An example of an emerging telecommunication standard is the 5G New Radio (NR). The 5G NR is a set of enhancements to the LTE mobile standard promulgated by the Third Generation Partnership Project (3GPP). It is designed to better support mobile broadband Internet access by improving spectral efficiency, reducing costs, improving services, and making use of a new spectrum, and to better integrate with other open standards, as well as to support beamforming, Multiple-Input Multiple-Output (MIMO) antenna technology, and carrier aggregation.

However, due to the technology-level differences, some functionalities and procedures of the LTE technology and the 5G NR technology may not be the same. Take the Scheduling Request (SR) procedure as an example. In the LTE technology, the same SR configuration may be shared by multiple pending SRs, and only a single SR procedure is allowed between a User Equipment (UE) and a serving cell. By contrast, in the 5G NR technology, the pending SRs may associate with multiple SR configurations, and multiple SR procedures are allowed between a UE and a serving cell. That is, multiple SR configurations are not supported in the LTE technology, but are supported in the 5G NR technology.

Therefore, the way of handling SR procedure(s) in the LTE technology may not work in the 5G NR technology, regarding the coexistence of multiple SR procedures.

### BRIEF SUMMARY OF THE APPLICATION

In order to solve the aforementioned problem, the present application proposes to allow multiple SR procedures ongoing between a UE and a serving cell, by the UE maintaining a respective set of SR parameters (e.g., the SR counter, SR prohibit-timer, and maximum number of SR transmission count) for each SR procedure. In addition, the present application proposes the UE to further handle the multiple SR procedures by canceling all ongoing SR procedures when any ongoing SR procedure fails.

In a first aspect of the application, a User Equipment (UE) comprising a wireless transceiver and a controller is provided. The wireless transceiver is configured to perform wireless transmission and reception to and from a serving cell. The controller is configured to perform a first Scheduling Request (SR) procedure and a second SR procedure with the serving cell via the wireless transceiver, and maintain a first set of SR parameters for the first SR procedure and a second SR counter and a second set of SR parameters, in response to performing the first SR procedure and the second SR procedure.

In a second aspect of the application, a method for a UE to handle multiple SR procedures is provided. The method comprises the steps of: performing a first SR procedure and a second SR procedure with a serving cell; and maintaining a first set of SR parameters for the first SR procedure and a second set of SR parameters for the second SR procedure, in response to performing the first SR procedure and the second SR procedure.

Other aspects and features of the present application will become apparent to those with ordinarily skill in the art upon review of the following descriptions of specific embodiments of the UEs and the methods for handling multiple SR procedures with a serving cell.

### BRIEF DESCRIPTION OF DRAWINGS

The application can be more fully understood by reading the subsequent detailed description and examples with references made to the accompanying drawings, wherein:

FIG. 1 is a block diagram of a wireless communication environment according to an embodiment of the application;

FIG. 2 is a block diagram illustrating the UE 110 according to an embodiment of the application;

FIGS. 3A and 3B show a message sequence chart illustrating the method for handling multiple SR procedures according to an embodiment of the application; and

FIG. 4 is a schematic diagram illustrating the time frame of the SR transmissions of the first and second SR procedures according to the embodiment of FIG. 3.

### DETAILED DESCRIPTION OF THE APPLICATION

The following description is made for the purpose of illustrating the general principles of the application and should not be taken in a limiting sense. It should be understood that the embodiments may be realized in software, hardware, firmware, or any combination thereof. The terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

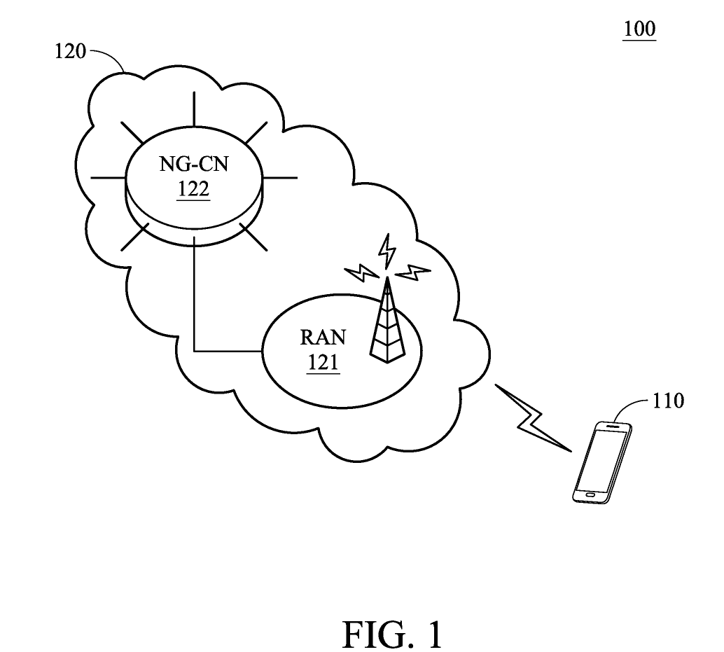

FIG. 1 is a block diagram of a wireless communication environment according to an embodiment of the application.

As shown in FIG. 1, the wireless communication environment 100 includes a User Equipment (UE) 110 and a 5G NR network 120, wherein the UE 110 may be wirelessly connected to the 5G NR network 120 for obtaining mobile services. For example, when the UE 110 has some data to send to the 5G NR network 120 but no uplink Shared Channel (UL-SCH) resources are available for data transmission in this Transmission Time Interval (TTI), the SR procedure may be triggered to request UL-SCH resources for data transmission. When an SR procedure is triggered, it is considered as pending until it is canceled. Please note that, in the present application, pending SR procedures may associate with multiple SR configurations, and multiple SR procedures between the UE 110 and a serving cell of the 5G NR network 120 are allowed.

The UE 110 may be a feature phone, a smartphone, a panel Personal Computer (PC), a laptop computer, or any wireless communication device supporting the cellular technology (i.e., the 5G NR technology) utilized by the 5G NR network 120. Particularly, the wireless communication device employs the beamforming technique for wireless transmission and/or reception.

The 5G NR network 120 includes a Radio Access Network (RAN) 121 and a Next Generation Core Network (NG-CN) 122.

The RAN 121 is responsible for processing radio signals, terminating radio protocols, and connecting the UE 110 with the NG-CN 122. The RAN 121 may include one or more cellular stations, such as gNBs, which support high frequency bands (e.g., above 24 GHz), and each gNB may further include one or more Transmission Reception Points (TRPs), wherein each gNB or TRP may be referred to as a 5G cellular station. Some gNB functions may be distributed across different TRPs, while others may be centralized, leaving the flexibility and scope of specific deployments to fulfill the requirements for specific cases.

A 5G cellular station may form at least one cell for providing mobile services to UEs. For example, a UE may camp on one or more cells formed by one or more gNBs or TRPs, wherein the cells which the UE is camped on may be referred to as serving cells, including a Primary cell (Pcell) and one or more Secondary cells (SCells).

The NG-CN 122 generally consists of various network functions, including Access and Mobility Function (AMF), Session Management Function (SMF), Policy Control Function (PCF), Application Function (AF), Authentication Server Function (AUSF), User Plane Function (UPF), and User Data Management (UDM), wherein each network function may be implemented as a network element on a dedicated hardware, or as a software instance running on a dedicated hardware, or as a virtualized function instantiated on an appropriate platform, e.g., a cloud infrastructure.

The AMF provides UE-based authentication, authorization, mobility management, etc. The SMF is responsible for session management and allocates Internet Protocol (IP) addresses to UEs. It also selects and controls the UPF for data transfer. If a UE has multiple sessions, different SMFs may be allocated to each session to manage them individually and possibly provide different functions per session. The AF provides information on the packet flow to PCF responsible for policy control in order to support Quality of Service (QoS). Based on the information, the PCF determines policies about mobility and session management to make the AMF and the SMF operate properly. The AUSF stores data for authentication of UEs, while the UDM stores subscription data of UEs.

It should be understood that the 5G NR network 120 depicted in FIG. 1 is for illustrative purposes only and is not intended to limit the scope of the application. For example, the application could be applied to other cellular technologies, such as a future enhancement of the 5G NR technology.

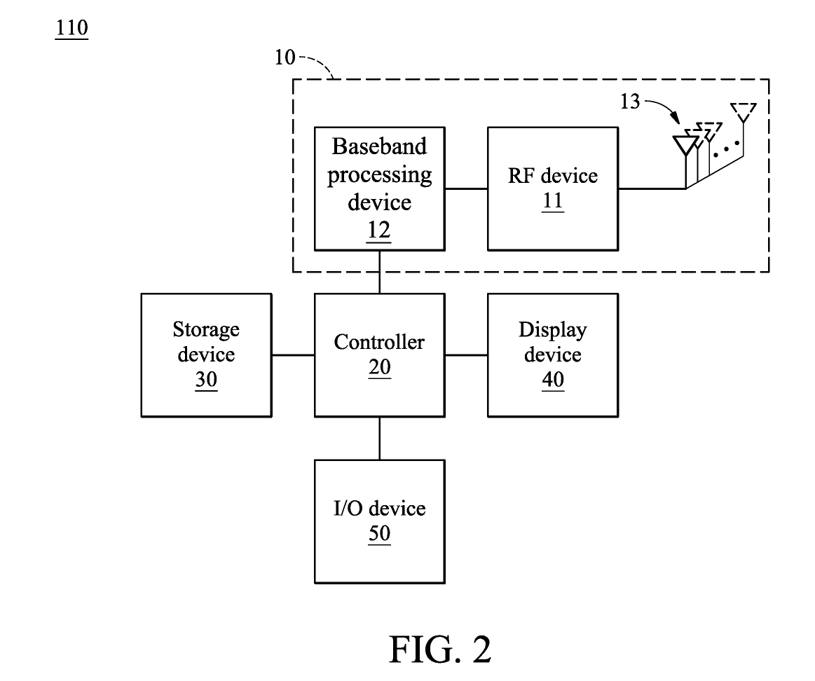

FIG. 2 is a block diagram illustrating the UE 110 according to an embodiment of the application.

As shown in FIG. 2, the UE 110 includes a wireless transceiver 10, a controller 20, a storage device 30, a display device 40, and an Input/Output (I/O) device 50.

The wireless transceiver 10 is configured to perform wireless transmission and reception to and from the cells formed by a gNB/TRP of the RAN 121. Specifically, the wireless transceiver 10 includes a Radio Frequency (RF) device 11, a baseband processing device 12, and antenna(s) 13, wherein the antenna(s) 13 may include one or more antennas for beamforming. The baseband processing device 12 is configured to perform baseband signal processing and control the communications between subscriber identity card(s) (not shown) and the RF device 11. The baseband processing device 12 may contain multiple hardware components to perform the baseband signal processing, including Analog-to-Digital Conversion (ADC)/Digital-to-Analog Conversion (DAC), gain adjusting, modulation/demodulation, encoding/decoding, and so on. The RF device 11 may receive RF wireless signals via the antenna(s) 13, convert the received RF wireless signals to baseband signals, which are processed by the baseband processing device 12, or receive baseband signals from the baseband processing device 12 and convert the received baseband signals to RF wireless signals, which are later transmitted via the antenna(s) 13. The RF device 11 may also contain multiple hardware devices to perform radio frequency conversion. For example, the RF device 11 may comprise a mixer to multiply the baseband signals with a carrier oscillated in the radio frequency of the supported cellular technologies, wherein the radio frequency may be any radio frequency (e.g., 30 GHz-300 GHz for mm Wave) utilized in the 5G NR technology, or another radio frequency, depending on the cellular technology in use.

The controller 20 may be a general-purpose processor, a Micro Control Unit (MCU), an application processor, a Digital Signal Processor (DSP), or the like, which includes various circuits for providing the functions of data processing and computing, controlling the wireless transceiver 10 for wireless communications with the gNB(s)/TRP(s) of the RAN 121, storing and retrieving data (e.g., program code) to and from the storage device 30, sending a series of frame data (e.g. representing text messages, graphics, images, etc.) to the display device 40, and receiving signals from the I/O device 50. In particular, the controller 20 coordinates the aforementioned operations of the wireless transceiver 10, the storage device 30, the display device 40, and the I/O device 50 for performing the method for handling multiple SR procedures.

In another embodiment, the controller 20 may be incorporated into the baseband processing device 12, to serve as a baseband processor.

As will be appreciated by persons skilled in the art, the circuits of the controller 20 will typically include transistors that are configured in such a way as to control the operation of the circuits in accordance with the functions and operations described herein. As will be further appreciated, the specific structure or interconnections of the transistors will typically be determined by a compiler, such as a Register Transfer Language (RTL) compiler. RTL compilers may be operated by a processor upon scripts that closely resemble assembly language code, to compile the script into a form that is used for the layout or fabrication of the ultimate circuitry. Indeed, RTL is well known for its role and use in the facilitation of the design process of electronic and digital systems.

The storage device 30 is a non-transitory machine-readable storage medium, including a memory, such as a FLASH memory or a Non-Volatile Random Access Memory (NVRAM), or a magnetic storage device, such as a hard disk or a magnetic tape, or an optical disc, or any combination thereof for storing instructions and/or program code of applications, communication protocols, and/or the method for handling multiple SR procedures.

The display device 40 may be a Liquid-Crystal Display (LCD), a Light-Emitting Diode (LED) display, an Organic LED (OLED) display, or an Electronic Paper Display (EPD), etc., for providing a display function. Alternatively, the display device 40 may further include one or more touch sensors disposed thereon or thereunder for sensing touches, contacts, or approximations of objects, such as fingers or styluses.

The I/O device 50 may include one or more buttons, a keyboard, a mouse, a touch pad, a video camera, a microphone, and/or a speaker, etc., to serve as the Man-Machine Interface (MMI) for interaction with users.

It should be understood that the components described in the embodiment of FIG. 2 are for illustrative purposes only and are not intended to limit the scope of the application. For example, the UE 110 may include more components, such as a power supply, or a Global Positioning System (GPS) device, wherein the power supply may be a mobile/replaceable battery providing power to all the other components of the UE 110, and the GPS device may provide the location information of the UE 110 for use of some location-based services or applications. Alternatively, the UE 110 may include less components. For example, the UE 110 may not include the display device 40 and/or the I/O device 50.

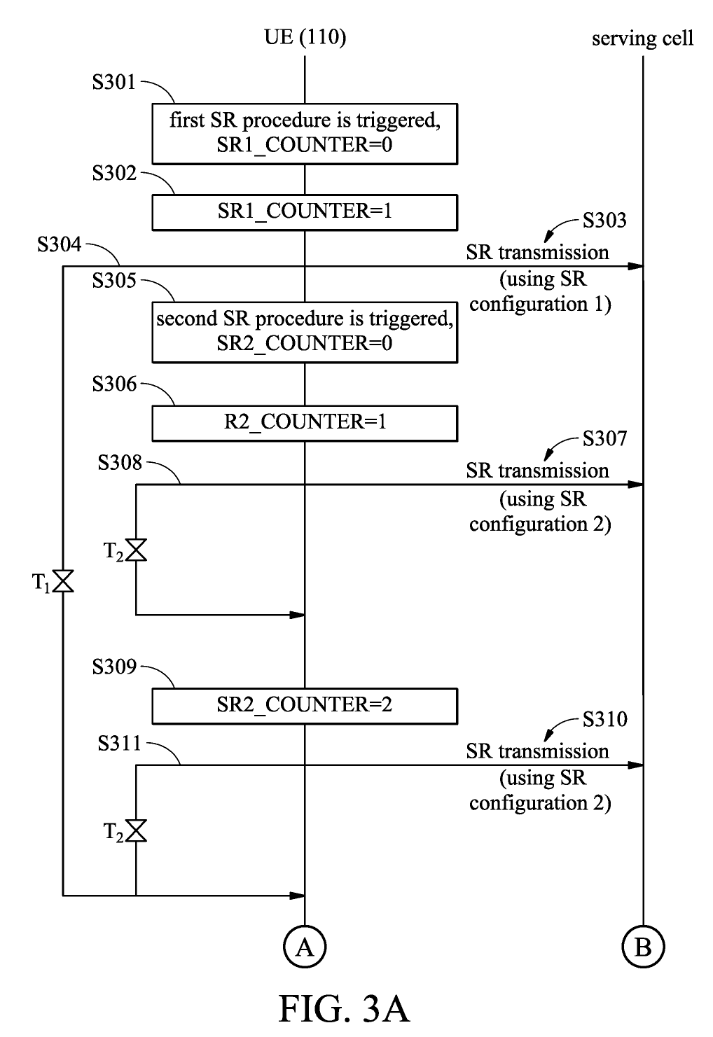

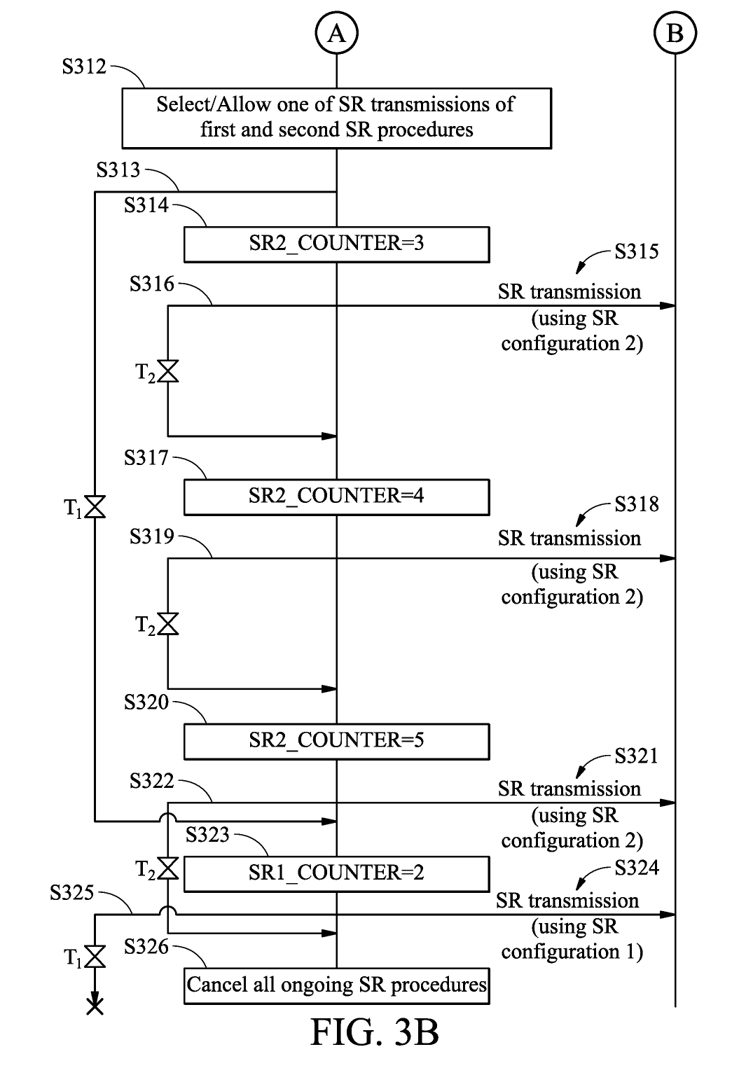

FIGS. 3A and 3B show a message sequence chart illustrating the method for handling multiple SR procedures according to an embodiment of the application.

In this embodiment, the method for handling multiple SR procedures is executed by the UE 110 and the UE 110 maintains a respective set of SR parameters (e.g., the SR counter, SR prohibit-timer, and maximum number of SR transmission count) for each SR procedure.

Specifically, the SR counter may refer to the SR parameter “SR_COUNTER” specified in the 3GPP specifications for the 5G NR technology, the SR prohibit-timer may refer to the SR parameter “sr-ProhibitTimer” specified in the 3GPP specifications for the 5G NR technology, and the maximum number of SR transmission count may refer to the SR parameter “sr-TransMax” specified in the 3GPP specifications for the 5G NR technology.

For convenience of understanding, the SR counter, the SR prohibit-timer, and the maximum number of SR transmission count of the first SR procedure are referred to herein as SR1_COUNTER, sr1-ProhibitTimer (denoted as T₁ for brevity), and sr1-TransMax, respectively. Likewise, the SR counter, the SR prohibit-timer, and the maximum number of SR transmission count of the second SR procedure are referred to herein as SR2_COUNTER, sr2-ProhibitTimer (denoted as T₂ for brevity), and sr2-TransMax, respectively.

To begin, the first SR procedure corresponding to the first SR configuration is triggered in response to that there's uplink traffic data associated with a LCH needed to be sent by the UE 110, and the UE 110 sets SR1_COUNTER to 0 since there are no other pending SR procedures corresponding to the same SR configuration (step S301).

Next, due to that SR1_COUNTER is less than sr1-TransMax (assumed to be 8), the UE 110 increments SR1_COUNTER by 1 (step S302), performs SR transmission using the first SR configuration (step S303), and starts sr1-ProhibitTimer (step S304).

After that, the second SR procedure corresponding to the second SR configuration is triggered in response to that there's uplink traffic data associated with another LCH needed to be sent by the UE 110, and the UE 110 sets SR2_COUNTER to 0 since there are no other pending SR procedures corresponding to the same SR configuration (step S305). That is, the first SR configuration is different from the second SR configuration, and the first SR procedure and the second SR procedure are not corresponding to the same SR configuration.

Next, due to that SR2_COUNTER is less than sr2-TransMax (assumed to be 5), the UE 110 increments SR2_COUNTER by 1 (step S306), performs SR transmission using the second SR configuration (step S307), and starts sr2-ProhibitTimer (step S308).

When sr2-ProhibitTimer expires, SR2_COUNTER is still less than sr2-TransMax, so the UE 110 increments SR2_COUNTER by 1 (step S309), performs SR transmission using the second SR configuration (step S310), and starts sr2-ProhibitTimer (step S311).

Subsequently, it is assumed that sr1-ProhibitTimer and sr2-ProhibitTimer expires roughly at the same time (which causes the SR transmissions of the first SR procedure and the second SR procedure to overlap in time), the UE 110 selects/allows one of the SR transmission of the first SR procedure and the SR transmission of the second SR procedure to be performed according to the priorities of the first SR configuration and the second SR configuration (step S312).

For example, the priorities of the first SR configuration and the second SR configuration may be determined according to at least one of the following: 1) the LCH priorities associated with the first SR configuration and the second SR configuration; 2) the Quality of Service (QoS) requirements or latency requirements of logical channels which trigger the first SR procedure and the second SR procedure; 3) the SR periodicities of the first SR configuration and the second SR configuration; 4) the time interval length from the first SR transmission to the next SR transmission of the first SR procedure, and the time interval length from the second SR transmission to the next SR transmission of the second SR procedure; and 5) the periods of times required for performing the first SR transmission and the second SR transmission.

In response that the SR transmission of the first SR procedure is not selected/allowed, the UE 110 starts sr1-ProhibitTimer (step S313). Next, due to that SR2_COUNTER is still less than sr2-TransMax, the UE 110 increments SR2_COUNTER by 1 (step S314), performs SR transmission using the second SR configuration (step S315), and starts sr2-ProhibitTimer (step S316).

Later, when sr2-ProhibitTimer expires, SR2_COUNTER is still less than sr2-TransMax, so the UE 110 increments SR2_COUNTER by 1 (step S317), performs SR transmission using the second SR configuration (step S318), and starts sr2-ProhibitTimer (step S319).

Again, when sr2-ProhibitTimer expires, SR2_COUNTER is still less than sr2-TransMax, so the UE 110 increments SR2_COUNTER by 1 (step S320), performs SR transmission using the second SR configuration (step S321), and starts sr2-ProhibitTimer (step S322).

Next, when sr1-ProhibitTimer expires and sr2-ProhibitTimer is still running, SR1_COUNTER is still less than sr1-TransMax, so the UE 110 increments SR1_COUNTER by 1 (step S323), performs SR transmission using the first SR configuration (step S324), and starts sr1-ProhibitTimer (step S325).

At last, when sr2-ProhibitTimer expires, SR2_COUNTER is no longer less than sr2-TransMax, so the UE 110 considers that the second SR procedure fails and the UE 110 cancels all ongoing SR procedures (step S326), and the method ends. That is, the UE 110 cancels all ongoing SR procedures, including the first SR procedure and the second SR procedure, in response to any ongoing SR procedure being failed.

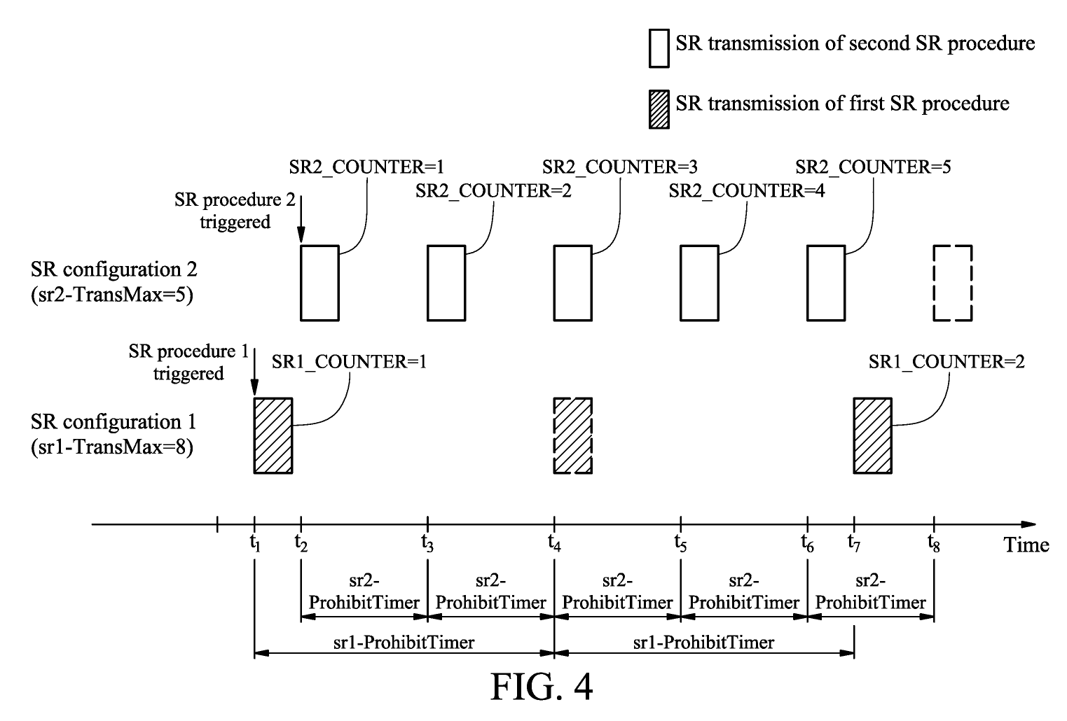

FIG. 4 is a schematic diagram illustrating the time frame of the SR transmissions of the first and second SR procedures according to the embodiment of FIG. 3.

As shown in FIG. 4, at time t1, the first SR procedure corresponding to the first SR configuration is triggered and the SR transmission of the first SR procedure is performed with SR1_COUNTER=1.

Next, at time t2, the second SR procedure corresponding to the second SR configuration is triggered and the SR transmission of the second SR procedure is performed with SR2_COUNTER=1.

After that, for the following two expiries of sr2-ProhibitTimer, two SR transmissions of the second SR procedure are performed at times t3 and t4 with SR2_COUNTER equal to 2 and 3, respectively.

In particular, although sr1 -ProhibitTimer also expires at time t4, the SR transmission of the first SR procedure is not allowed to be performed. Instead, the SR transmission of the second SR procedure is allowed due to that the priority of the second SR configuration is higher than the priority of the first SR configuration. In response to not allowing the SR transmission of the first SR procedure, the sr1-ProhibitTimer is started.

Subsequently, for the following two expiries of sr2-ProhibitTimer, two SR transmissions of the second SR procedure are performed at times t5 and t6 with SR2_COUNTER equal to 4 and 5, respectively.

Next, when sr1-ProhibitTimer expires at time t7, the SR transmission of the first SR procedure is performed with SR1_COUNTER=2.

At last, when sr2-ProhibitTimer expires at time t8, the UE 110 considers that the second SR procedure fails and the UE 110 cancels all ongoing SR procedures, due to that SR2_COUNTER is no longer less than sr2-TransMax (assumed to be 5).

In view of the forgoing embodiments, it will be appreciated that the present application allows multiple ongoing SR procedures, by the UE maintaining a respective set of SR parameters (e.g., the SR counter, SR prohibit-timer, and maximum number of SR transmission count) for each SR procedure. Moreover, the present application realizes further handling of the multiple SR procedures by the UE canceling all ongoing SR procedures when any ongoing SR procedure fails.

While the application has been described by way of example and in terms of preferred embodiment, it should be understood that the application is not limited thereto. Those who are skilled in this technology can still make various alterations and modifications without departing from the scope and spirit of this application. Therefore, the scope of the present application shall be defined and protected by the following claims and their equivalents.

Use of ordinal terms such as “first”, “second”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

What is claimed is:

1. A User Equipment (UE), comprising:
a wireless transceiver, configured to perform wireless transmission and reception to and from a serving cell; and
a controller, configured to perform a first Scheduling Request (SR) procedure and a second SR procedure with the serving cell via the wireless transceiver, and maintain a first set of SR parameters for the first SR procedure and a second set of SR parameters for the second SR procedure, in response to performing the first SR procedure and the second SR procedure.

2. The UE of claim 1, wherein the first set of SR parameters comprise a first SR counter, a first SR prohibit-timer, and a first maximum number of SR transmission count, and the second set of SR parameters comprise a second SR counter, a second SR prohibit-timer, and a second maximum number of SR transmission count.

3. The UE of claim 2, wherein the controller is further configured to set the first SR counter or the second SR counter to 0 in response to the first SR procedure or the second SR procedure being triggered and the first SR procedure and the second SR procedure not corresponding to the same SR configuration.

4. The UE of claim 2, wherein the controller is further configured to increment the first SR counter by 1 for an SR transmission of the first SR procedure in response to the first SR counter being less than the first maximum number of SR transmission count, and increment the second SR counter by 1 for an SR transmission of the second SR procedure in response to the second SR counter being less than the second maximum number of SR transmission count.

5. The UE of claim 4, wherein the first SR procedure or the second SR procedure fails in response to the first SR counter not being less than the first maximum number of SR transmission count or the second SR counter not being less than the second maximum number of SR transmission count, and the controller is further configured to cancel all ongoing SR procedures in response to the first SR procedure or the second SR procedure being failed.

6. The UE of claim 1, wherein, in response to a first SR transmission of the first SR procedure and a second SR transmission of the second SR procedure overlapping in time, the controller is further configured to allow one of the first SR transmission and the second SR transmission according to priorities of a first SR configuration used for the first SR procedure and a second SR configuration used for the second SR procedure.

7. The UE of claim 6, wherein the priorities of the first SR configuration and the second SR configuration are determined according to at least one of the following:
Logical Channel (LCH) priorities associated with the first SR configuration and the second SR configuration;
Quality of Service (QoS) requirements or latency requirements of logical channels which trigger the first SR procedure and the second SR procedure;
SR periodicities of the first SR configuration and the second SR configuration;
a first time interval length from the first SR transmission to the next SR transmission of the first SR procedure and a second time interval length from the second SR transmission to the next SR transmission of the second SR procedure; and
periods of times required for performing the first SR transmission and the second SR transmission.

8. A method for a UE to handle multiple SR procedures, comprising:
performing a first SR procedure and a second SR procedure with a serving cell; and
maintaining a first set of SR parameters for the first SR procedure and a second set of SR parameters for the second SR procedure, in response to performing the first SR procedure and the second SR procedure.

9. The method of claim 8, wherein the first set of SR parameters comprise a first SR counter, a first SR prohibit-timer, and a first maximum number of SR transmission count, and the second set of SR parameters comprise a second SR counter, a second SR prohibit-timer, and a second maximum number of SR transmission count.

10. The method of claim 9, further comprising:
setting the first SR counter or the second SR counter to 0 in response to the first SR procedure or the second SR procedure being triggered and the first SR procedure and the second SR procedure not corresponding to the same SR configuration.

11. The method of claim 9, further comprising:
incrementing the first SR counter by 1 for an SR transmission of the first SR procedure in response to the first SR counter being less than the first maximum number of SR transmission count; and
incrementing the second SR counter by 1 for an SR transmission of the second SR procedure in response to the second SR counter being less than the second maximum number of SR transmission count.

12. The method of claim 11, wherein the first SR procedure or the second SR procedure fails in response to the first SR counter not being less than the first maximum number of SR transmission count or the second SR counter not being less than the second maximum number of SR transmission count, and the method further comprises:
canceling all ongoing SR procedures in response to the first SR procedure or the second SR procedure being failed.

13. The method of claim 8, further comprising:
in response to a first SR transmission of the first SR procedure and a second SR transmission of the second SR procedure overlapping in time, allowing one of the first SR transmission and the second SR transmission according to priorities of a first SR configuration used for the first SR procedure and a second SR configuration used for the second SR procedure.

14. The method of claim 13, wherein the priorities of the first SR configuration and the second SR configuration are determined according to at least one of the following:
LCH priorities associated with the first SR configuration and the second SR configuration;
QoS requirements or latency requirements of logical channels which trigger the first SR procedure and the second SR procedure;
SR periodicities of the first SR configuration and the second SR configuration;
a first time interval length from the first SR transmission to the next SR transmission of the first SR procedure, and a second time interval length from the second SR transmission to the next SR transmission of the second SR procedure; and
periods of times required for performing the first SR transmission and the second SR transmission.
